(19) United States
(12) Patent Application Publication
(10) Pub. No.: US 2025/0355196 A1
(43) Pub. Date: Nov. 20, 2025

(54) A SPRING RELEASE DEVICE FOR RELEASE OPERATION OF A CONNECTOR

(71) Applicant: Lambda Networks AS, Oslo (NO)

(72) Inventors: Johan Henæs, Son (NO); William KEMPTON, Oslo (NO); Marius ANDRESEN, Oslo (NO)

(21) Appl. No.: 18/872,251

(22) PCT Filed: Oct. 17, 2023
(86) PCT No.: PCT/NO2023/060074

§ 371 Date: Dec. 5, 2024

(30) Foreign Application Priority Data
Oct. 17, 2022 (NO) 20221110
Oct. 19, 2022 (NO) 20221120
Jan. 11, 2023 (NO) 20230022

(51) Int. Cl. G02B 6/38

(52) U.S. Cl. CPC G02B 6/3893; G02B 6/3897

(57) ABSTRACT

The disclosure relates to a spring release device for release operation of a connector comprising: a first portion for mounting in a receiving connector panel, a second portion for interacting with an inserted connector being inserted into a receiving connector for releasing the inserted connector.

### TECHNICAL FIELD

The present disclosure relates to a spring release device for release operation of a connector. More specifically, the disclosure relates to a spring release device for release operation of a connector as defined in the introductory parts of the independent claim.

### BACKGROUND ART

In the industry of fiber distribution systems, there are manufactured many types of distribution frame systems for hosting multiple fiber cables, often in hundreds. A problem with the solutions of the prior art is that the space for connectors are often restricted and connectors are clustered with tight fitting layouts. The way the connectors are designed, they are easy to connect, male into female parts of the connectors, but if space is limited it may be a real problem to disconnect connectors if necessary. The industry has come up with special tools for reaching difficult to reach connectors, or expansion panes for creating more free space between the connected fiber cables. The workarounds are either difficult to use, expensive both in cost and space, or not practical. There is thus a need for improved way to solve problem of disconnecting connected fiber cables.

### SUMMARY

It is an object of the present disclosure to mitigate, alleviate or eliminate one or more of the above-identified deficiencies and disadvantages in the prior art and solve at least the above mentioned problem. According to a first aspect there is provided a spring release device for release operation of a connector comprising: a first portion being arranged in a receiving connector panel, a second portion for interacting with an inserted connector arranged in a receiving connector panel for releasing an inserted connector.

It is provided an easy to produce and attach spring release device which interacts with an inserted connector part of a connector. Typically the spring release device is adapted to the form factor of an LC, “Little connector”, connector. The LC connector was developed by Lucent Technologies and is a more evolutionary approach to achieving the goals of a SFF (small form factor) fiber connector. But, the present disclosure is to encompass any connector type that are provided with any type of latch release portion, also within different technologies than fiber cables are in use. One such example is the RJ45 Jack which normally is provided with a latch/clip for release operation. It is also possible to adapt the techniques to other fiber connectors such as for example the MT-RJ, Mechanical Transfer-Registered Jack.

According to some embodiments, the spring release device comprises: attachment means for securing the spring release device in a receiving connector panel.

According to some embodiments, the second portion has one or more spring portions, each spring portion having at least one conduit, the conduit being arranged to receive a latch and/or yoke of an inserted connector.

Thereby, a variety of jack configurations may be received by the same spring release device.

According to some embodiments the second portion comprises an upper portion, a fold back portion, and a lower portion, wherein the lower portion is folded back to be aligned and substantially parallel with the underside of the upper portion, the lower portion comprises conduits which is aligned with the conduits of the upper portion, and the fold back portion providing an elastic spring connection between the lower portion and the upper portion.

Thus, a more flexible elastic spring action may be provided for the release action.

According to some embodiments the lower portion further comprising on its sides a protruding spring action area for easy reach of an operator to activating a release operation of an inserted connector, such that when the protruding spring action area is pushed down the lower portion moves down and connects with and pushes down a received latch and/or yoke of an inserted connector.

The spring action area allows a more easy operable release action.

According to some embodiments the conduit of the lower portion has a protruding tap arranged in the conduit side positioned furthest from the first portion, the protruding tap is arranged with an angle α to protect against hang-up and to allow for sliding into and out of the conduits of the upper portion and for providing a sliding effect when receiving or releasing a latch and/or yoke of an inserted connector.

Thus, prohibiting any potential hang-up between the spring release device and the

According to some embodiments, the conduit has a protruding tap arranged in the conduit side positioned closest to the first portion.

According to some embodiments, the protruding tap is arranged to bend downwards and pointing away from the first portion for easy interaction with a latch arranged on an inserted connector.

The protruding tap ensures contact between the spring release device and the release portion of the connector that is to be released.

According to some embodiments, the conduit has a protruding sliding tap arranged in the conduit side positioned farthest from the first portion for interacting with a yoke of an inserted connector and easy release when inserted connector is released.

A yoke portion, if present, may be equipped with a barbed upper back surface, originally provided for improved finger resistance, but, when mounted in a spring release device as here provided, the protruding sliding tap will ensure that the connector is not stuck in the conduit.

According to some embodiments, the attachment means are arranged on both sides of the second portion towards the first portion, or the attachment means are arranged on both sides of the first portion, and comprise protruding side taps for being inserted in an opening holes in side walls of a panel module such that when the spring release device is mounted the attachment means will hold to the side walls of a panel module.

It is advantageously to provide holding means securing the spring release device in a module panel. This may further also resisting widening of the module panels of a module the receiving connectors are mounted in, when the spring release device is operated.

According to some embodiments, the spring release device is arranged to release an LC fiber connector.

According to some embodiments, the spring release device is made of a thin resilient material.

The spring release device will then easily return to its initial form and position after being pushed to release a connector. It can be used for receiving and releasing connectors again and again.

According to some embodiments, the second portion is split by a longitudinal running gap into two portions able to individual release a sideways arranged pair of inserted connectors.

The connectors, specifically the LC connector tends to be provided in a paired version where two sideways connectors are mounted to tow fiber cables. However it may be advantageous to be able to release only one connector at a time, and thus the spring release device is provided with a split to be able to operate only one half of the connected pair at a time.

According to some embodiments, second portion conduit is arranged to receive a dual format latch and/or yoke for simultaneous release of a sideways arranged pair of inserted connectors.

Likewise, there is provided a version of the spring release device that may release both of a pair of connectors simultaneously simply by pushing only one of the sides of the spring release device.

According to some embodiments, second portion further the spring comprises on its side a protruding action area for easy reach of an operator when activating a release operation of an inserted connector.

According to some embodiments, second portion further the spring comprises on its posterior end a protruding sliding area for easy positioning and sliding of a connector when an operator inserting a connector into a receiving connector.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIGS. 1A and 1B shows prior art male LC connectors, single and dual, and an exploded view of the latch and yoke portions.

FIG. 2A-2D shows a first embodiment of the spring release device of present disclosure.

FIG. 2E-2H shows a second embodiment of the spring release device of present disclosure.

FIG. 2I shows a second release mechanism of the second embodiment of the spring release device of present disclosure.

FIG. 2J shows a third release mechanism of the second embodiment of the spring release device of present disclosure.

FIG. 2K shows the second release mechanism seen from above on a dual spring release device.

FIG. 3A-3C shows how the spring release device of present disclosure may be installed in a LC module panel and operated when a male connector is connected and released.

FIGS. 4A and 4B show two alternative embodiments of the spring release device according to present disclosure.

FIG. 5 show a collection of views of a further embodiment of the spring release device according to present disclosure.

FIG. 6 show how the spring release device in FIG. 5 is installed in a module panel.

FIG. 7 to FIG. 15 is a portion of a presentation planned for future display, presenting the spring release device according to the present disclosure.

FIGS. 16, 17A and 17B exemplifies use embodiments of the spring device as shown in FIG. 2E-2H.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

FIG. 1A and FIG. 1B shows how an LC connector in different forms may be provided for providing connectivity of a fiber cable.

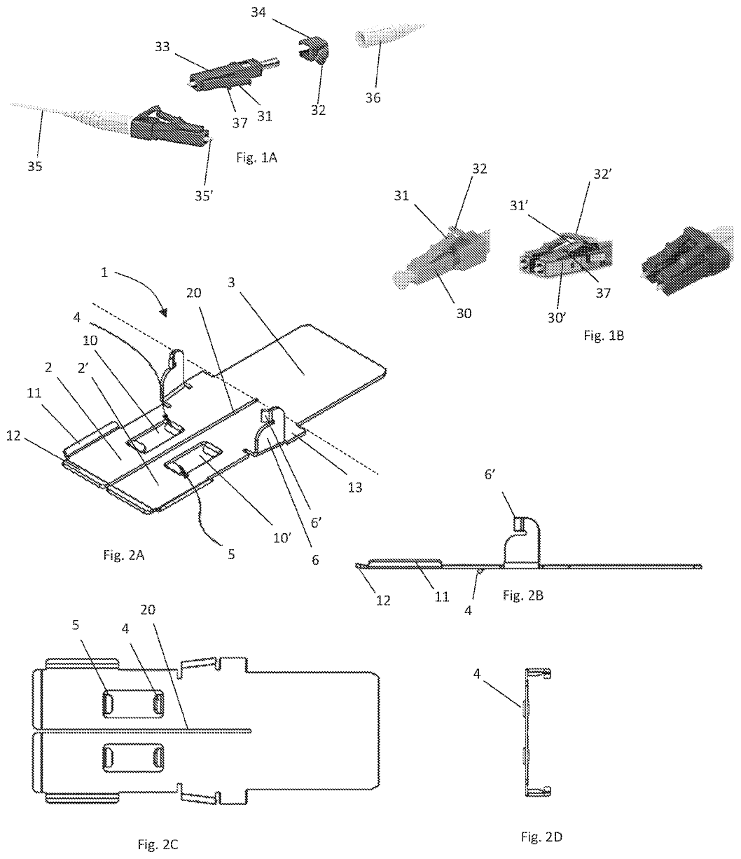

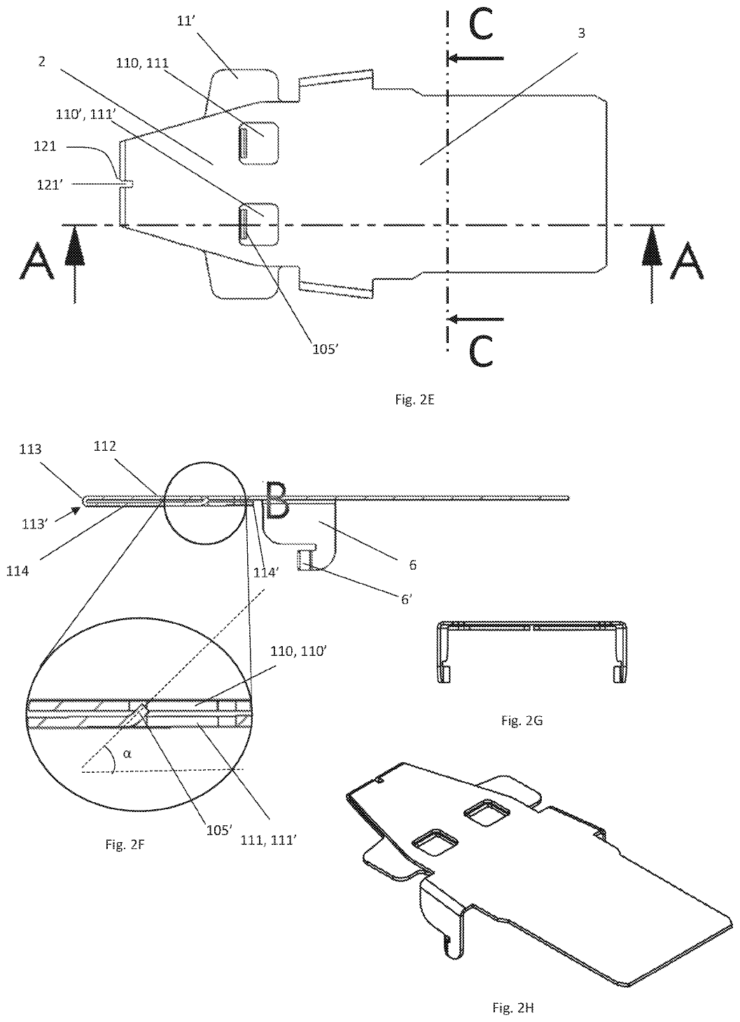

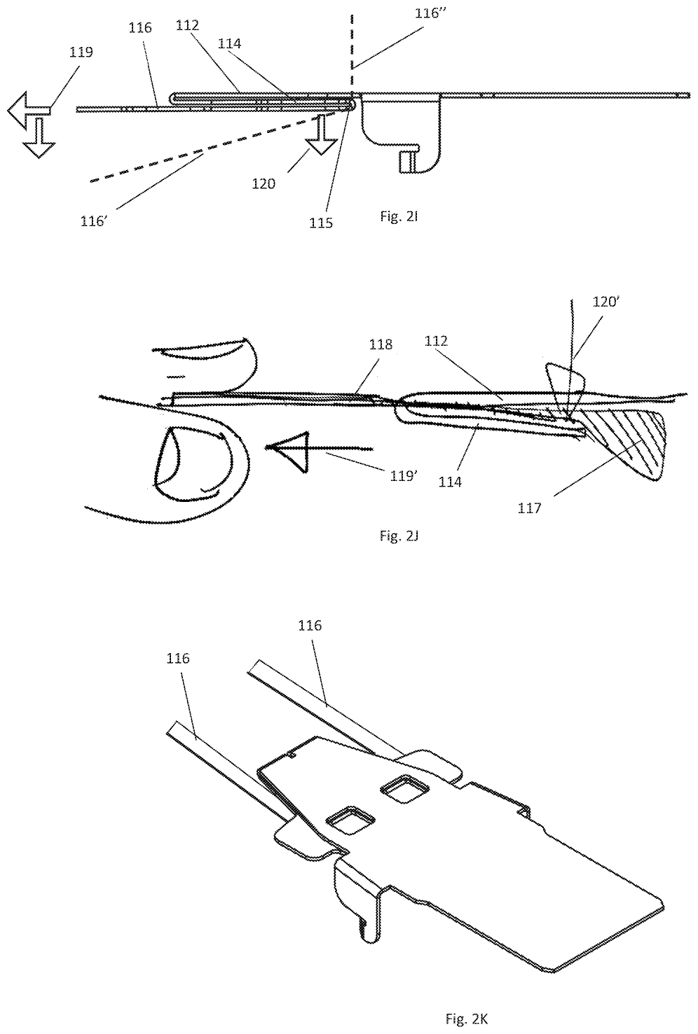

FIG. 2A to 2H shows different view angles of spring release devices according to present disclosure.

The first aspect of this disclosure shows a spring release device 1 for release operation of a connector 30, 30′ comprising: a first portion 3 for being arranged in a receiving connector panel 50, a second portion 2,2′ for interacting with an inserted connector 30,30′ being inserted into a receiving connector 40 arranged in a receiving connector panel for releasing an inserted connector 30,30′.

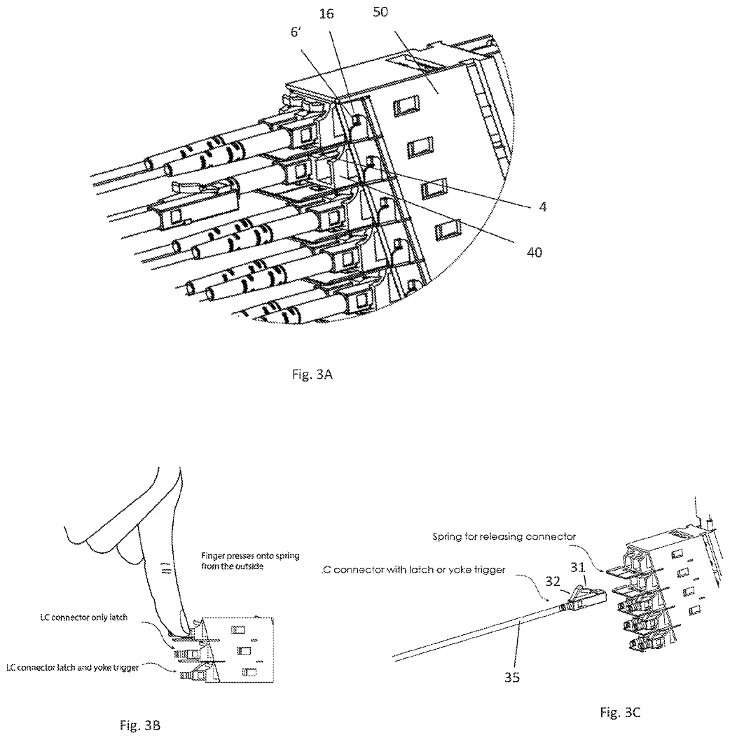

In FIG. 2A the dotted line 60 indicates the border between the first portion 3 and the second portion, wherein the first portion is formed to fit inside a receiving connector panel wherein the receiving connectors 40 are mounted. As can be seen in for example FIG. 3A it is often desirable to group fiber cable connectors together pairwise and in stacked pairs above each other's in a slightly overhang angled front of the connector panel. The spring release devices 1 is arranged above and to the corresponding receiving connector(s) it is going to serve, such that the first portion 3 is fixedly mounted inside the receiving connector panel 50, and the second portion 2,2′ is arranged to protrude over and outside the receiving connector(s) 40 for interacting with a connector being inserted into the receiving connector 40, for interacting with an inserted connector 30, 30′.

The spring release device 1 may be cut out from a single template, and is thus provided as a no-moving-part solution once installed in the connector panel. Thus, providing a simple to produce, cheap, reliable and easy to operate solution to the above discussed problems.

The spring release device 1 may comprise attachment means 6,7 for securing the spring release device 1 in a receiving connector panel 50.

For each connector/receiving connector pair 30,30′, 40, 40′ that is to be provided with the release feature of the spring release devices 1 must have a spring release devices 1 mounted.

The second portion 2,2′ may comprise one or more spring portions, each spring portion having at least one conduit 10, 110, 110′, 111, 111′, the conduit 10, 110, 110′, 111, 111′ being arranged to receive a latch 31 and/or yoke 32,32′ of an inserted connector 30,30′. The latch 31 typically comprise locking means 37 for interacting with a corresponding locking means (not shown) in a receiving connector 40 in a connector panel 50.

Looking at the LC connector, as an example for visualizing the features of the spring release device 1 according to the present disclosure, as shown in FIG. 1A, an inserting portion of the fiber cable connector may comprise a latch portion 33, and an optional yoke portion 34. The latter is not mandatory but is often used to improve the availability of the release latch 31 of the latch portion 34. When mounted together the yoke portion 34 comprising the yoke 32 may be pushed, and then the pushing action is forwarded to the latch 31 of the latch portion, which again releases the locking means 37 of the inserted connector 30, 30′.

The spring release device 1, when mounted correctly over each connector pair in the connector panel, will receive either the latch 31, or the latch 31 and the yoke 32 when present, into the conduit 10, 110, 110′, 111, 111′ of the spring release device 1. The operation and state of the latch 31 and the yoke 32 is thereby uninterrupted when arranging the connector into the receiving connector 40. The spring release device 1 may have on its posterior end a protruding sliding area 12, 113′ for easy positioning and sliding of a connector 30, 30′ when an operator inserting a connector 30, 30′ into a receiving connector (40). The protruding sliding area 12, 113′ may advantageously be angled upwards.

In the embodiment illustrated with FIG. 2E to 2H it is shown a spring release device 1 wherein the second portion 2 comprises an upper portion 112, a fold back portion 113, and a lower portion 114, wherein the lower portion 114 is folded back to be aligned and substantially parallel with the underside of the upper portion 112, the lower portion 114 comprises conduits 111, 111′ which is aligned with the conduits 110, 110′ of the upper portion, and the fold back portion 113 providing an elastic spring connection between the lower portion 114 and the upper portion 112. This embodiment of the spring release device 1 is formed such that it is to be arranged above the connector it is to secure/release. Different to some of the other embodiments discussed in present disclosure, the deployment of the spring release device 1 can be installed for all the receiving connectors of the receiving connector panel 50. In this embodiment the attachment means 6 point downwards relative the first 3 and second 2 portion.

The aligned conduits 110, 110′, 111, 111′ of the upper and lower portions 112, 114 is arranged for providing an opening for receiving the latch portion 33, and an optional yoke portion 34 of the fiber cable connector 30, 30′ when the cable connector is pushed all the way into the receiving connector 40.

The fold back portion 113 is provided by in the production process folding the lower portion 114 downwards and 180° relative the upper portion 112 folding completely backwards to a parallel position on the underside of the upper portion 112, such that it is configured to keep its new form after production. The material of the spring release device 1 is typically a material, for example metal, that will provide an elastic spring effect, such that if the lower portion 114 is pushed/bent away from the upper portion, it will spring back to its fold back position once the pushing force is released.

According to some embodiments the lower portion 114 further comprising on its sides a protruding spring action area 11′ for easy reach of an operator to activating a release operation of an inserted connector 30, 30′, such that when the protruding spring action area 11′ is pushed down the lower portion 114 moves down and connects with and pushes down a received latch 31 and/or yoke 32, 32′ of an inserted connector 30, 30′. The lower portion 114 may comprise a split 121 in the longitudinal direction. The split may be even be continued as far as through the fold back portion 113 and a small portion 121′ of the upper portion 112 in order to make the lower portion even more flexible/bendable. The most distal end 114′ of the lower portion should in a passive mode just touch the underside of the upper portion 12 without tension.

According to some embodiments the conduit 111, 111′ of the lower portion 114 has a protruding tap 105′ arranged in the conduit 111, 111′ side positioned furthest from the first portion 3, wherein the protruding tap 105′ is arranged with an angle α to protect against hang-up and to allow for sliding into and out of the conduits 110, 110′ of the upper portion and for providing a sliding effect when receiving or releasing a latch 31 and/or yoke 32, 32′ of an inserted connector 30, 30′. The angle α may be close to 90°. The protruding tap 105′ has the double action where it is guiding the lower portion 114 back into an aligned position when being operated, as well as providing an angled solid edge-free surface for interacting with the latch portion 33, and an optional yoke portion 34 of the fiber cable connector 30, 30′ such that the connector may be easily entered and released into/from the receiving connector 40.

In a further embodiment as shown in FIG. 2I the second portion comprise a further fold back portion 115 at the distal end of the lower portion 114. The further fold back portion 115 folds an extension release grip 116 downwards and 180° relative the lower portion 114 which provides for operating the release mechanism from a position outside the connector panel. The extension release grip is in the figure shown as running substantially parallel with the lower portion, but it should be understood that a second version of the extension release grip 116′ may be angled relative the lower portion 114 to optimize installation and operation process. When the extension release grip is pulled outwards or downwards 119 the lower portion 114 is pulled downwards 120, and the release operation of an inserted connector 30, 30′ can be activated. It may even be provided at third version of the extension release grip 116″ being attached to the distal end of the lower portion 114 and arranged to extend upwards in order to access and operate the release operation of an inserted connector 30, 30′ from above by pushing the third version of the extension release grip 116″ downwards.

In a further embodiment as shown in FIG. 2J a wedge element 117, 118, comprising a wedge 117 and an activation grip 118, is provided to be inserted and moved into the gap between the upper portion 112 and the lower portion 114 from the distal end of the lower portion 114, such that when the activation grip 118 is pulled in the direction 119′ from the distal end of the lower portion 114 towards the fold back portion 113, the wedge 117 is pressed into the gap between the upper portion 112 and the lower portion 114, and the lower portion 114 is pushed downwards 120′ in order to access and operate the release operation of an inserted connector 30, 30′.

The extension grips provided in FIGS. 2I and 2J may be adapted to operate either single or dual format latch 31, 31′ and/or yoke 32, 32′, the latter either individually or in pair. FIG. 2K illustrates one possible embodiment wherein a dual format latch 31′ and/or yoke 32′ is provided for separate operation with an extension release grip 116. It should be understood that this is similarly implemented for the wedge solution.

The conduit 10 may have a protruding tap 4,4′ arranged in the conduit 10 side positioned closest to the first portion 3. The protruding tap 4, 4′ is advantageously arranged to rest on or close to the upper surface of the latch 31. Thus, when the spring portion 2, 2′ of the spring release device 1 is pushed by an operator, the protruding tap 4, 4′ will quickly make contact with the latch 31 and push it down. Then the inserted connector 30, 30′ will release and it is possible to pull the inserted connector free from the receiving connector. The spring release device 1 makes it easy to operate the release action even when the latch 31 itself is unreachable due to tight mounting of multiple connectors.

The protruding tap 4,4′ may thus be arranged to bend downwards and pointing away from the first portion 3 for easy interaction with a latch 31 arranged on an inserted connector 30,30′. The down and away bending of the protruding tap 4, 4′ may even be arranged to contact a forward pointing barb on the latch 31.

The conduit 10 may further comprise a protruding sliding tap 5,5′ arranged in the conduit 10 side positioned farthest from the first portion 3 for interacting with a yoke 32,32′ of an inserted connector 30,30′ and easy release when inserted connector is released.

The yoke 32, 32′ may come in many forms, one popular version has backward oriented barbs for better grip by an operator finger 99. When a connector having the yoke 32, 32′ is inserted in the connector panel 50 as discussed in present disclosure, and the yoke is arranged in the conduit 10 space when the connector is connected to the receiving connector, the protruding sliding tap 5, 5′ is provided to ensure that the barbed of the yoke 32, 32′ does not lock a grip towards the rear end of the conduit 10 when the connector is released.

The attachment means 6 may be arranged on both sides of the second portion 2,2′ towards the first portion 3, or the attachment means 7 are arranged on both sides of the first portion 3, and comprise protruding side taps 6′,7′ for being inserted in an opening holes 16,17 in side walls of a panel module 50 such that when the spring release device 1 is mounted the attachment means 6,6′,7,7′ will hold to the side walls of a panel module 50. Thus the spring release device 1 may be firmly held in place.

In a first embodiment as shown in FIG. 2A-2D the attachment means 6 is a protruding element arranged on the side of the second portion 2, 2′ adjacent to the stopper element 13. The protruding element of the attachment means 6 stretches at an orthogonal angle up from the spring release device 1, and may have a slight skewed angle in the longitudinal direction. The width 21 of the narrowest portion of the orthogonal upward pointing portion of the attachment means 6 is adapted to the outer width of the receiving portion 51 of the panel module 50 in order for the protruding side taps 6′ to “click” into corresponding opening holes 16.

The holding action of the attachment means 6, 7 shown may also in fact increase the robustness of the wall positions of the panel module 50 in that the spring release device 1 in fact is acting as a reinforcement of the structure of the panel module. It should be understood that the attachment means could be provided by a number of other techniques, such as different design, gluing, screwing, soldering, “click action”, mechanical friction and other.

A further sideways protruding stopper tabs 13 may be arranged on the second portion 2, 2′ of the spring release device 1 to provide for a correct insertion arrangement when inserting the spring release device 1 into a panel module 50. The panel module having corresponding receiving slots 13′ such that when the spring release device 1 is inserted and the protruding stopper tabs 13 are lead into the receiving slots 13′, the spring release device 1 will slide inwards until the inner portion of the protruding stopper tabs 13 reaches the bottom of the receiving slot 13′. At this point the protruding side taps 6′,7′ of the attachment means 6, 7 will connect and slide into the corresponding opening holes 16,17 in side walls of a panel module 50.

In the embodiments shown in the figures the spring release device 1 is arranged to release an LC fiber connector 30,30′. It should be understood that the spring release device 1 according to the present disclosure shall not be limited to LC fiber cable 35 connectors.

It is advantageous that the spring release device 1 according to present disclosure is made of a thin resilient material. It could in one embodiment be made of thin aluminum, stainless steel, or spring steel in a format where thin is in millimeters or even less than 1 mm. It should be thin enough in stainless steel embodiment where it should be easy to bend the second part 2, 2′ down to release the connector 32, 32′. The material can also be of a different material, such as for example, but not limited to: enforced or non-enforced polymer based compound, carbon based fiber, metal compound, or other.

The second portion 2,2′ may be split by a longitudinal running gap 20 into two portions, as illustrated in FIG. 2A, to provide for individual release of a sideways arranged pair of inserted connectors 30.

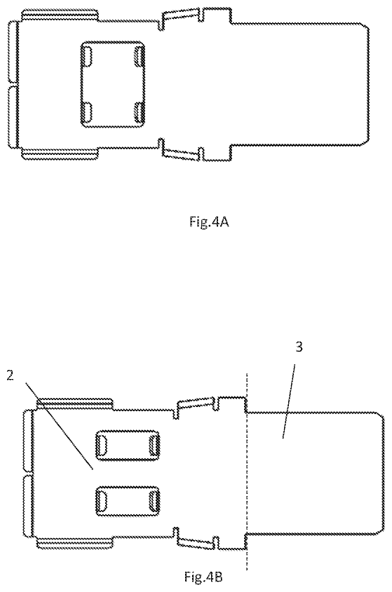

In a further embedment second portion 2,2′ conduit may be arranged to receive a dual format latch 31′ and/or yoke 32′, as illustrated in FIGS. 4A and 4B, for simultaneous release of a sideways arranged pair of inserted connectors 30′. The embodiment in FIG. 4A may also receive a dual yoke 32′ as seen in FIG. 1B.

The second portion 2,2′ may further comprise on its side a protruding action area 11 for easy reach of an operator when activating a release operation of an inserted connector 30,30′. This protruding action area 11 may increase the visibility, for the finger 99 of an operator, of the spring release device 1.

The second portion 2,2′ may further comprise on its posterior end a protruding sliding area 12 for easy positioning and sliding of a connector 30,30′ when an operator inserting a connector 30,30′ into a receiving connector 40.

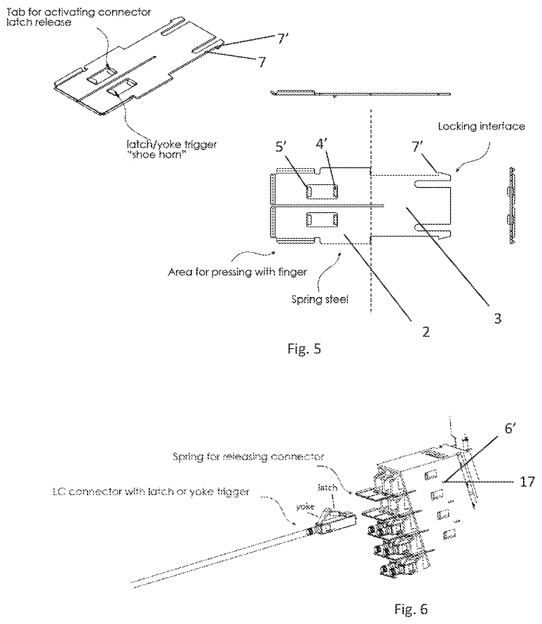

FIG. 5 shows an alternative embodiment of the spring release device 1, wherein the attachment means 7 is arranged on the posterior end of the first portion 3 of the spring release device 1. Each attachment means 7 is arranged on a protrusion having a longitudinal recess 7″ for providing an elastic movement of the protrusion when installing the spring release device 1 in a panel module 50. When the spring release device 1 is pushed in the protrusion and attachment means 7 will click into the corresponding opening hole 17 on the side of the of the panel module 50.

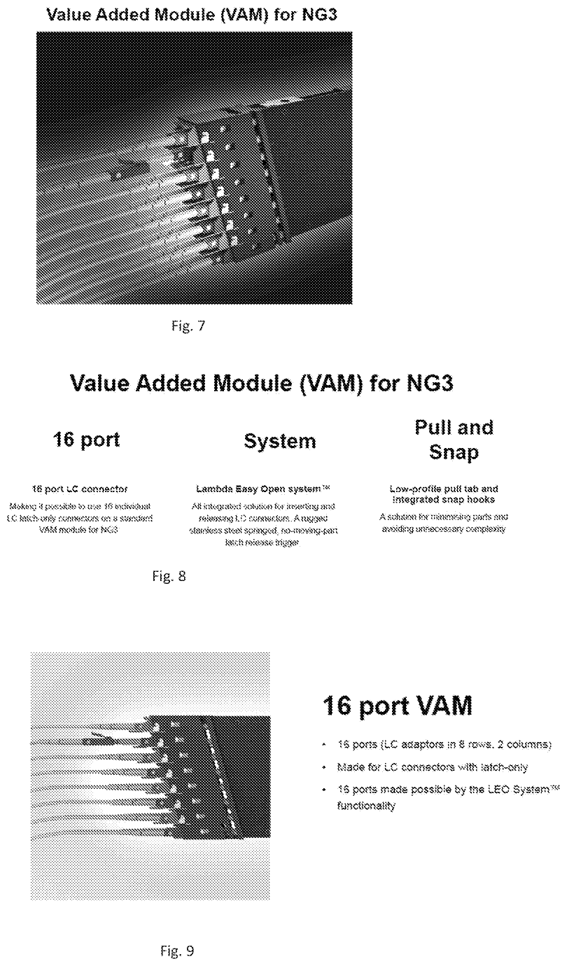

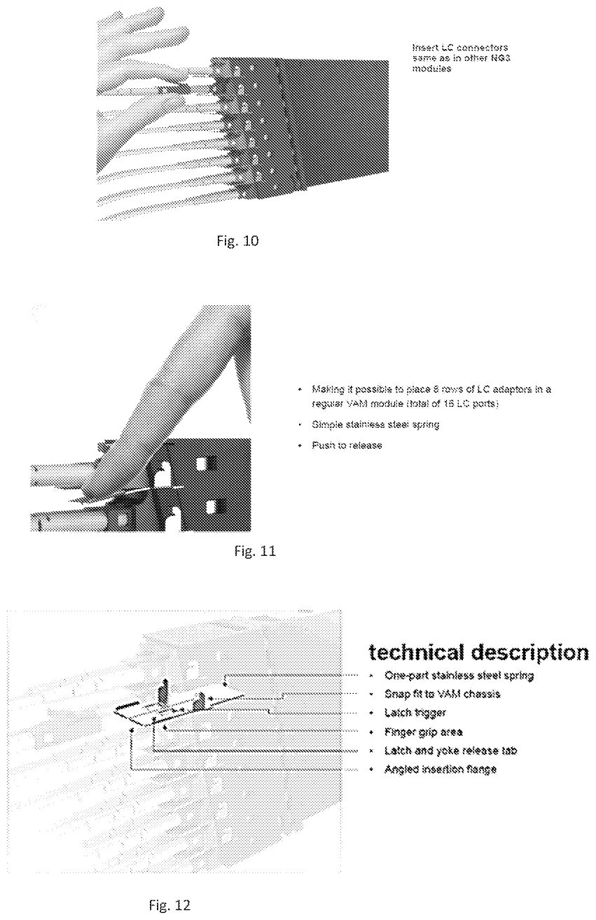

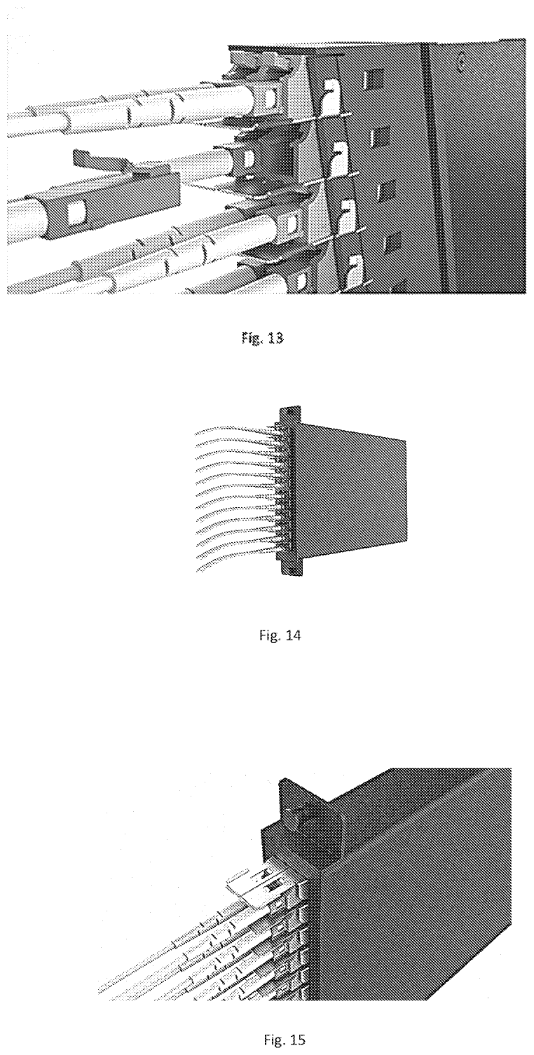

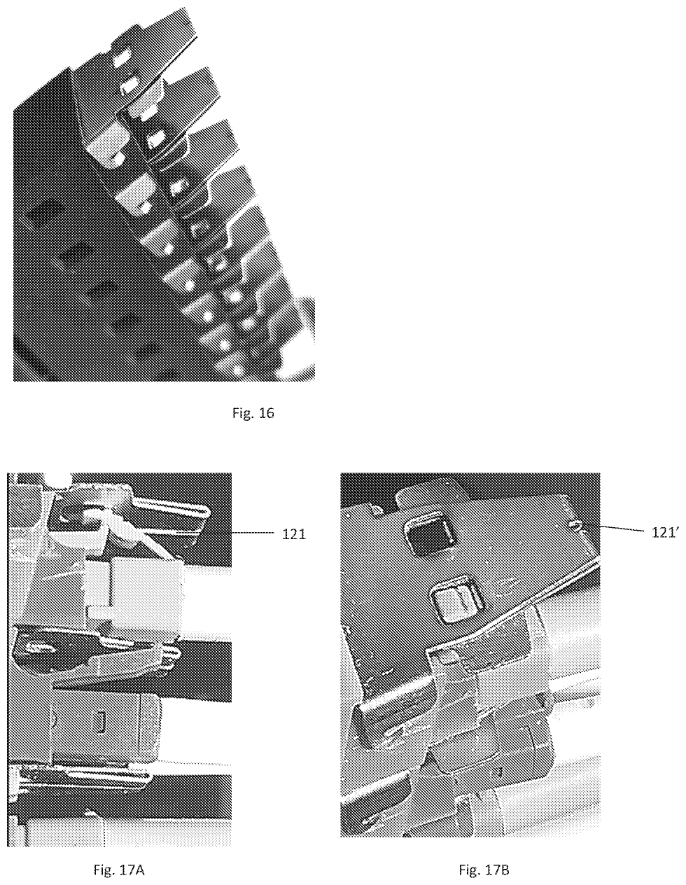

The embodiments shown in FIG. 7 to FIG. 15 shows picture for how the spring release device 1 may be adapted to be implemented in connection with a Value Added Module, VAM, for a high density fiber distribution frame system. In this it is provided an embodiment making it possible to use 16 individual LC latch-only connectors on a standard VAM module. The embodiment provides an all integrated solution for inserting and releasing LC connectors. A rugged stainless steel spring, non-moving-part, latch release trigger according to present disclosure is employed.

FIGS. 14 and 15 exemplifies a further embodiment of the spring release device 1 comprise downwards oriented attachment means 6,6′ wherein protruding side taps 6′ of the attachment means 6 will connect and slide into corresponding opening holes 16,17 in side walls of a panel module 50 adapted for the downward oriented attachment means 6, 6′.

The person skilled in the art realizes that the present disclosure is not limited to the preferred embodiments described above. The person skilled in the art further realizes that modifications and variations are possible within the scope of the appended claims. For example. Additionally, variations to the disclosed embodiments can be understood and effected by the skilled person in practicing the claimed disclosure, from a study of the drawings, the disclosure, and the appended claims.

1. A spring release device for a release operation of a connector comprising:
a first portion configured to be arranged in a receiving connector panel; and
a second portion for interacting with an inserted connector, the second portion configured to be inserted into a receiving connector arranged in the receiving connector panel for releasing the inserted connector,
wherein the second portion comprises one or more spring portions, each spring portion of the one or more spring portions comprising at least one conduit, the at least one conduit arranged to receive a latch and/or yoke of the inserted connector,
wherein the second portion further comprises an upper portion, a fold back portion, and a lower portion,
wherein the lower portion is folded back to be aligned and substantially parallel with an underside of the upper portion,
wherein the lower portion comprises a first plurality of conduits of the at least one conduit and the upper portion comprises a second plurality of conduits of the at least one conduit, the first plurality of conduits of the lower portion aligned with the second plurality of conduits of the upper portion, and
wherein the fold back portion provides an elastic spring connection between the lower portion and the upper portion.

2. The spring release device according to claim 1, further comprising:
attachment means for securing the spring release device in the receiving connector panel.

3. (canceled)

4. (canceled)

5. The spring release device according to claim 1, wherein the lower portion further comprises, on sides of the lower portion, a protruding spring action area configured for easy reach of an operator to activate the release operation of the inserted connector, such that, when the protruding spring action area is pushed down, the lower portion moves down and connects with and pushes down a received latch and/or yoke of the inserted connector.

6. The spring release device according to claim 1, wherein the first plurality of conduits of the lower portion comprises a protruding tap arranged in a side of the first plurality of conduits positioned furthest from the first portion, and
wherein the protruding tap is arranged with an angle to protect against hang-up and to allow for sliding into and out of the second plurality of conduits of the upper portion and for providing a sliding effect when receiving or releasing the latch and/or yoke of the inserted connector.

7. The spring release device according to claim 1, wherein a conduit of the at least one conduit comprises a protruding tap arranged in a side of the conduit positioned closest to the first portion.

8. The spring release device according to claim 7, wherein the protruding tap is arranged to bend downwards and point away from the first portion for easy interaction with a latch arranged on the inserted connector.

9. The spring release device according to claim 1, wherein
a conduit of the at least one conduit comprises a protruding sliding tap arranged in a side of the conduit positioned farthest from the first portion for interacting with a yoke of the inserted connector and for easy release when the inserted connector is released.

10. The spring release device according to claim 1, wherein the second portion further comprises, on a side of the second portion, a protruding action area for easy reach of an operator when activating the release operation of the inserted connector.

11. The spring release device according to claim 2, wherein the attachment means are arranged on both sides of the second portion towards the first portion, or
wherein the attachment means are arranged on both sides of the first portion, and comprise protruding side taps configured to be inserted in opening holes in side walls of a panel module, such that, when the spring release device is mounted, the attachment means hold to the side walls of the panel module.

12. The spring release device according to claim 1, wherein the spring release device is arranged to release an LC fiber connector.

13. The spring release device according to claim 1, wherein the spring release device comprises a thin resilient material.

14. The spring release device according to claim 1, wherein the second portion is split by a longitudinal running gap into two portions able to individually release a sideways arranged pair of inserted connectors.

15. The spring release device according to claim 1, wherein the at least one conduit of the second portion is arranged to receive a dual format latch and/or yoke for simultaneous release of a sideways arranged pair of inserted connectors.

16. The spring release device according to claim 1, wherein the second portion further comprises, on a posterior end of the second portion, a protruding sliding area for easy positioning and sliding of the inserted connector when an operator inserts the inserted connector into the receiving connector.

17. The spring release device according to claim 1, further comprising a further fold back portion at a distal end of the lower portion,
wherein the further fold back portion folds an extension release grip downwards, 180° relative to the lower portion, for providing operation of a release mechanism from a position outside the receiving connector panel.
